(19) United States
(12) Patent Application Publication
(10) Pub. No.: US 2024/0303635 A1
(43) Pub. Date: Sep. 12, 2024

(54) TOKEN-BASED OFF-CHAIN INTERACTION AUTHORIZATION

(71) Applicant: Visa International Service Association, San Francisco, CA (US)

(72) Inventors: Benjamin Price, Rockingham, VA (US); Yuexi Chen, Foster City, CA (US); Mahdi Zamani, Mercer Island, WA (US); Ranjit Kumaresan, Sunnyvale, CA (US); Mihai Christodorescu, San Francisco, CA (US)

(73) Assignee: Visa International Service Association, San Francisco, CA (US)

(21) Appl. No.: 18/259,063

(22) PCT Filed: Jan. 13, 2021
(86) PCT No.: PCT/US2021/013316

§ 371 Date: Jun. 22, 2023

(51) Int. Cl. G06Q 20/36; G06Q 20/38; G06Q 20/40

(52) U.S. Cl. CPC G06Q 20/3674; G06Q 20/3825; G06Q 20/401

(57) ABSTRACT

Methods and systems for token-based off-chain interaction authorization are disclosed. A hub computer can maintain a network of off-chain (or “layer two”) channels between itself, cryptocurrency issuer computers, and cryptocurrency custodian computers. These off-chain channels correspond to one or more underlying blockchains. The hub computer can receive an access token, a resource provider identifier, and an interaction value. The hub computer can use the access token to identify a cryptocurrency issuer computer associated with the mobile device, and use the resource provider identifier to identify the cryptocurrency custodian computer associated with the access device. The hub computer can update the state of the off-chain channels corresponding to these two computers based on the interaction value, then transmit an authorization response message.

### BACKGROUND

Blockchain technologies, such as cryptocurrencies, are increasingly popular for facilitating interactions between participants. However, there are a number of problems preventing widespread adoption of these technologies.

One such problem is that Blockchain technologies currently aren't very user friendly. Participants often need special knowledge or equipment in order to make use of these technologies. As such, few commercial organizations support such blockchain technologies. Currently, there are only approximately 15,000 businesses worldwide that are able to accept bitcoin as payment for transactions. Thus, even if a person possesses bitcoin, there is a low likelihood that they can use it to pay for goods or services.

This problem exists, in part, because cryptocurrencies cannot be used with existing interaction authorization infrastructure (i.e., payment processing networks). Unlike a credit card, which can be used at most businesses, and for which there are well established networks and protocols, cryptocurrency transfer typically involves the direct transfer from one cryptocurrency wallet to another. If either participant does not have a cryptocurrency wallet, the transfer cannot take place.

Additionally, blockchains are poorly equipped to handle large volumes of transactions. The Bitcoin blockchain currently supports less than 7 transactions per second. By contrast, during the 2013 holidays, at peak, Visa processed approximately 47,000 transactions per second. As such, achieving Visa-like capacity on the Bitcoin network is currently infeasible, another problem that prevents widespread adoption of cryptocurrencies.

Embodiments address these and other problems, individually and collectively.

### SUMMARY

Embodiments of the present disclosure are directed to methods and systems for authorizing cryptocurrency-based interactions (e.g., payment transactions) using tokenization and off-chain channels. Embodiments, when used in conjunction with payment processing networks (such as VisaNet™), enable users to perform cryptocurrency-based interactions with resource providers (e.g., merchants) in a manner similar to conventional credit card transactions. Using embodiments, resource providers can accept cryptocurrencies at traditional point of sale terminals, without any additional technological burden. Embodiments provide more convenience for customers, who can use cryptocurrencies to pay resource providers who typically would be unable to accept them. Further, the use of off-chain channels, described in more detail below, enables embodiments to overcome the transaction rate limits associated with blockchains such as Bitcoin.

In brief, a hub computer establishes and maintains off-chain channels with one or more cryptocurrency issuer computers and one or more cryptocurrency custodian computers. The cryptocurrency issuer computers maintain digital wallets for users (e.g., customers). The cryptocurrency custodian computers manage cryptocurrencies for resource providers, acquirers, and other entities (including, in some cases, the hub computer, or the entity owning or operating the hub computer).

These “off-chain channels” exist outside of their corresponding blockchain. The off-chain channel effectively allows the parties on the channel to transact without broadcasting each individual transaction to the underlying blockchain. Typically, only an initial broadcast is needed to establish the channel, and a second broadcast is needed to close the channel, allowing the participants on the channel to conduct an arbitrary number of cryptocurrency transactions while only broadcasting a small, finite number of “transactions” to the underlying blockchain.

During an interaction (e.g., a transaction) between a resource provider (merchant) and a user of a mobile device (e.g., a consumer operating a smartphone) the mobile device, or a wallet application operating on the mobile device, can generate a cryptogram comprising data comprising one or more of: transaction information, an “interaction value” (e.g., the transaction amount or cost), a resource provider identifier, and/or a digital wallet token. This cryptogram can be transmitted to an access device (e.g., a point-of-sale terminal), which can route the cryptogram to a processing network computer (which may be part of a payment processing network such as a VisaNet™) via an acquirer computer (e.g., a computer system associated with the resource provider's bank). The cryptogram may be present in an authorization request message that is transmitted from the access device to the processing network computer via the acquirer computer.

After receiving the cryptogram, the processing network computer can decrypt the cryptogram and analyze its contents, including the digital wallet token. Based on the contents of the cryptogram, the processing network computer can determine that the transaction is a cryptocurrency-based transaction, and forward the contents to the hub computer. In some embodiments, the hub computer and processing network computer may form a single entity (e.g., a single system).

Using the contents of the cryptogram such as the digital wallet token, the hub computer can retrieve an access token corresponding to the cryptocurrency issuer computer. Using the resource provider identifier, the hub computer can also determine the cryptocurrency custodian computer. Off-chain interaction channels may be formed between the hub computer and the cryptocurrency issuer computer, and the hub computer and the cryptocurrency custodian computer.

The hub computer can request authorization for the interaction (transaction) from the cryptocurrency issuer computer. If the cryptocurrency issuer computer approves the transaction, the hub computer and the cryptocurrency issuer computer can update the current state of their off-chain channel based on the interaction value from the cryptogram. Afterwards, the hub computer can update the state of the off-chain channel between the hub computer and the cryptocurrency custodian computer.

Embodiments of the invention provide for cryptographically secure, enforceable, promises from the cryptocurrency issuer computer to deliver the requested amount of cryptocurrency to the cryptocurrency custodian computer via the hub computer. After the off-chain channels are updated, the hub computer can transmit an authorization response message to the access device. This authorization response message, much like a traditional credit card authorization response message, indicates to the resource provider that the interaction has been successfully authorized, and they can provide the user (e.g., customer) with the resource (good or service) that the user requests.

While the example above focused on commercial business applications, embodiments of the present disclosure can be applied to any number of applicable blockchain based, resource provision applications. A user could, for example, use this technology to check out books from a library (resource provider) that maintains their lending records using blockchains and off-chain channels.

One embodiment is directed to a method comprising: receiving, by a hub computer, an access token and an interaction value for an interaction; determining, by the hub computer, a cryptocurrency issuer address using the access token, the cryptocurrency issuer address associated with a cryptocurrency issuer computer; transmitting, by the hub computer, to the cryptocurrency issuer computer, a first off-chain interaction request comprising the interaction value; receiving, by the hub computer, from the cryptocurrency issuer computer, a first off-chain interaction response comprising a cryptocurrency issuer computer cryptographic signature, wherein the first off-chain interaction request occurs in a first off-chain interaction channel between the hub computer and the cryptocurrency issuer computer, the first off-chain interaction channel formed by at least a first initial recordation between the cryptographic hub computer and the cryptocurrency issuer computer on a blockchain; and transmitting, by the hub computer, an authorization response message for the interaction.

Another embodiment is directed to a hub computer comprising: a processor; and a non-transitory computer readable medium coupled to the processor, the non-transitory computer readable medium comprising code, executable by the processor, for performing steps comprising: receiving an access token and an interaction value for an interaction; determining a cryptocurrency issuer address using the access token, the cryptocurrency issuer address associated with a cryptocurrency issuer computer; transmitting, to the cryptocurrency issuer computer, a first off-chain interaction request comprising the interaction value; receiving, from the cryptocurrency issuer computer, a first off-chain interaction response comprising a cryptocurrency issuer computer cryptographic signature, wherein the first off-chain interaction request occurs in a first off-chain interaction channel between the hub computer and the cryptocurrency issuer computer, the first off-chain interaction channel formed by at least a first initial recordation between the hub computer and the cryptocurrency issuer computer on a blockchain; and transmitting, by the hub computer, an authorization response message for the interaction.

Another embodiment is directed to a method comprising: receiving, by a cryptocurrency issuer computer, a communication comprising an initial value from an application on a mobile device of a user for an interaction, the application associated with the cryptocurrency issuer computer; receiving, by the cryptocurrency issuer computer, an off-chain interaction request comprising an interaction value from a hub computer, the interaction value received by the hub computer interacting with the mobile device, wherein the off-chain interaction request occurs in an off-chain interaction channel between the hub computer and the cryptocurrency issuer computer, the off-chain interaction channel formed by at least an initial recordation between the hub computer and the cryptocurrency issuer computer on a blockchain; signing, by the cryptocurrency issuer computer, interaction data including the interaction value to form a cryptocurrency issuer computer cryptographic signature; transmitting by the cryptocurrency issuer computer, to the hub computer, an off-chain interaction response comprising the cryptocurrency issuer computer cryptographic signature; and transmitting, by the cryptocurrency issuer computer, a confirmation message to the application on the mobile device for the interaction.

These embodiments, among others, are described in more detail below with reference to the figures.

### Terms

Some descriptions of some terms may be helpful prior to discussing embodiments of the present disclosure.

A “server computer” may include a powerful computer or cluster of computers. For example, the server computer can include a large mainframe, a minicomputer cluster, or a group of servers functioning as a unit. In one example, the server computer can include a database server coupled to a web server. The server computer may comprise one or more computational apparatuses and may use any of a variety of computing structures, arrangements, and compilations for servicing the requests from one or more client computers.

A “memory” may include any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation.

A “processor” may include any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or XScale; and/or the like processor(s).

An “application” may be a computer program that is used for a specific purpose.

An “identifier” may include data used to identify something. This may include an object, entity (such as a person or business entity), computer system, transaction, method, etc.

A “token” may be a substitute value for a credential. An “access token” may be a token used to access something. A token may be a string of numbers, letters, or any other suitable characters. Examples of access tokens include digital wallet tokens (substituting for a digital wallet credential), virtual payment account numbers (VPANs), personal identification tokens, etc.

A “key pair” may include a pair of linked cryptographic keys. For example, a key pair can include a public key and a corresponding private key. In a key pair, a first key (e.g., a public key) may be used to encrypt a message, while a second key (e.g., a private key) may be used to decrypt the encrypted message. Additionally, a public key may be able to verify a digital signature created with the corresponding private key. The public key may be distributed throughout a network in order to allow for verification of messages signed using the corresponding private key. Public and private keys may be in any suitable format, including those based on RSA or elliptic curve cryptography (ECC).

A “digital signature” may include any electronic signature for a message. A digital signature may be a numeric data value, an alphanumeric data value, or any other type of data. In some embodiments, a digital signature may be a unique data value generated from a message (or data packet) and a private key using a cryptographic algorithm. In some embodiments, a validation algorithm using a public key may be used to verify the signature. A digital signature may be used to demonstrate the veracity of the sender.

A “cryptogram” may include any packet of encrypted data. A cryptogram may be used to securely transmit sensitive data (such as transaction data or interaction data) through a public network such as the Internet.

A “hash” or “hash value” may include any data element produced using a “hashing function.” A hashing function may be used to transform data of arbitrary size to data of fixed size (for example, 1 KB). A hash function may be used to generate commitments to secret data, such as a secret token, without revealing the secret data itself. Some hash functions are “collision resistant,” meaning it is difficult to determine two inputs that produce the same hash output. Collision resistant hash functions can be used as a security feature in blockchains.

A “blockchain” may include a database that maintains a continuously-growing list of records secured from tampering and revision. A blockchain may include a number of blocks of event records recorded by one or more peers. Each block in the blockchain can contain also include a timestamp and a link to a previous block. For example, each block may include a hash of the previous block. Stated differently, event records in a blockchain may be stored as a series of “blocks,” or permanent files that include a record of a number of events occurring over a given period of time. Blocks may be appended to a blockchain by an appropriate peer after it completes the block and the block is validated. In embodiments of the invention, a blockchain may be distributed, and a copy of the blockchain may be maintained at each peer in a blockchain network.

A “node” of a blockchain may include a computer or software node. In some cases, each node in a blockchain network has a copy of a digital ledger or blockchain. Each node checks the validity of each transaction. In some cases, if a majority of nodes say that a transaction is valid then it is written into a block.

An “off-chain channel” or “off-chain interaction channel” may include a channel used to perform cryptocurrency transactions or micro-transactions without broadcasting to the underlying blockchain. An off-chain channel may be referred to as a “layer two channel.” Channels in the Lightning Network are examples of off-chain channels. In some implementations, an off-chain channel may be opened by broadcasting a “funding transaction” or “opening transaction” to the blockchain. The participants on the off-chain channel can then perform cryptocurrency transactions with one another without broadcasting to the blockchain. The off-chain channel can be closed by broadcasting a “commitment transaction” or “closing transaction,” at which point the funds on the off-chain channel are distributed to the participants.

An “electronic wallet” or “digital wallet” may include an electronic device or service that allows an individual to conduct electronic commerce transactions. A digital wallet may store user profile information, credentials, bank account information, one or more digital wallet identifiers and/or the like and can be used in a variety of transactions, such as, but not limited to, eCommerce transactions, social network transactions, money transfer/personal payment transactions, mobile commerce transactions, proximity payment transactions, gaming transactions, etc. A digital wallet may be designed to streamline the purchase and payment process. A digital wallet may allow the user to load one or more payment cards onto the digital wallet so as to make a payment without having to enter an account number or present a physical card. Digital wallets may also be used manage cryptocurrencies and execute cryptocurrency transactions, including, for example, receiving cryptocurrencies at a cryptocurrency address associated with the digital wallet holder or transmitting cryptocurrencies to other cryptocurrency addresses. A digital wallet may have a corresponding “digital wallet token” that can be used in place of another digital wallet credential in order to perform transactions or receive authorization for transactions.

A “cryptocurrency transaction” may include a payment transaction that utilizes cryptocurrency instead of fiat currency. Cryptocurrency transactions may include (but are not limited to) transactions using Bitcoin, Ethereum, and USDC. Cryptocurrency transactions may further be processed by a blockchain network. Responsive to processing, cryptocurrency transactions may be added to a ledger of transactions included within the blockchain network.

A “cryptocurrency transaction identifier” may include any suitable data element that identifies a cryptocurrency transaction. For example, a cryptocurrency transaction identifier may be a string of alphanumeric characters. In some embodiments, a cryptocurrency transaction identifier may be a hashed value.

A “cryptocurrency address” may include an identifier that indicates a destination and/or a source for a cryptocurrency payment. For example, a cryptocurrency address may be a string of at least 26 to 35 alphanumeric characters. As another example, a cryptocurrency address may be a public key. Each cryptocurrency transaction may include a cryptocurrency address of a sender (e.g., a source of a cryptocurrency payment) and a cryptocurrency address of a recipient (e.g., a destination of a cryptocurrency payment).

A “user” may include any user of some object or service. This may include, for example, a user of a “mobile device” such as a smartphone, or a user of a payment card (e.g., a credit or debit card). A user may be associated with one or more personal accounts (e.g., payment accounts) or user devices. A user may be referred to as a “cardholder” (when possessing or using a payment card), an account holder (when possessing or using an account), or a consumer (when using goods or services provided by relying entities and resource providers).

A “resource provider” may include any suitable entity that provides resources (e.g., goods, services, access to secure data, access to locations, or the like) to other entities, such as users. For example, a resource providing entity can be a merchant, a venue operator, a building owner, a governmental entity, etc. A “merchant” may typically be an entity that engages in transactions and can sell goods or services, or provide access to goods or services.

A “mobile device” may include any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g., when a device has remote access to a network by tethering to another device—i.e., using the other device as a modem—both devices taken together may be considered a single mobile device).

An “access device” may include any suitable device for providing access to an external computer system. An access device may be in any suitable form. Some examples of access devices include point of sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a mobile device.

An “acquirer” may include an entity that processes payments on behalf of a resource provider, such as a merchant. An acquirer may comprise a financial institution, such as a bank, that maintains an account for a merchant. An acquirer may operate an “acquirer computer,” a computer system that can be used to transmit payment information through networks such as the Internet, including, for example, authorization request messages and authorization response messages

A “token provider computer” may include a system that services tokens. In some embodiments, a token provider computer can facilitate requesting, determining (e.g., generating) and/or issuing tokens, as well as maintaining an established mapping of tokens to primary account numbers (PANs) or virtual primary account numbers (VPANs) in a repository (e.g. token vault). In some embodiments, the token provider computer may establish a token assurance level for a given token to indicate the confidence level of the token to PAN binding. The token provider computer may include or be in communication with a token vault where the generated tokens are stored. The token provider computer may support token processing of payment transactions submitted using tokens by de-tokenizing the token to obtain the actual PAN. In some embodiments, a token provider computer may include a tokenization computer alone, or in combination with other computers such as a processing network computer or hub computer. Various entities of a tokenization ecosystem may assume the roles of the token service provider. For example, payment networks and issuers or their agents may act as token service providers by implementing token services.

A “processing network computer” may include a system that can support and deliver data services. A processing network computer can be in a “payment processing network” that may include data processing subsystems, networks, server computers and operations used to support and deliver authorization services, exception file services, and clearing and settlement services. A payment processing network may be any suitable network able to transmit and receive financial system transaction messages (e.g., ISO 8583 messages), and process original credit and debit card transactions. An exemplary payment processing system may include VisaNet™. Payment processing systems such as VisaNet™ are able to process credit card transactions, debit card transactions, and other types of commercial transactions.

A “cryptocurrency issuer” may include an entity that manages a cryptocurrency account on behalf of a user. A cryptocurrency issuer may also broker exchanges between different cryptocurrencies or cryptocurrencies and fiat currencies. A cryptocurrency issuer may issue or provide a digital wallet application to a user. This digital wallet application may be used by the user in order to perform cryptocurrency transactions. When a user performs a cryptocurrency transaction, the cryptocurrency issuer may approve or deny that transaction, in order to prevent fraudulent spending of the user's cryptocurrency funds.

A “cryptocurrency custodian” may include an entity that provides storage and security services for cryptocurrencies. These may include, for example, storing cryptocurrencies for other financial organizations, such as banks (including acquiring entities) and hedge funds. A cryptocurrency custodian may maintain a cryptocurrency account on behalf of an acquirer. In some cases, a cryptocurrency issuer and cryptocurrency custodian may comprise a single entity. In some embodiments, a cryptocurrency custodian can also be a cryptocurrency exchange, where cryptocurrencies can be bought or sold with fiat currency.

“Transaction data” may be data that is associated with a payment transaction. Transaction data may include a transaction amount, a date of a transaction, a primary account number associated with a user initiating the transaction.

“Authentication data” may include any data suitable for verifying something. Authentication data may include data authenticating a user or a mobile device. Authentication data may be obtained from a user or a device that is operated by the user. Examples of authentication data obtained from a user may include PINs (personal identification numbers), biometric data, passwords, etc. Examples of authentication data that may be obtained from a device may be include device serial numbers, hardware secure element identifiers, device fingerprints, phone numbers, IMEI numbers, etc.

An “authorization request message” may include any electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCW (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may include any electronic message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. PA equipment) that indicates approval of the transaction. The code may serve as proof of authorization.

### BRIEF DESCRIPTION OF THE DRAWINGS

FIG. 1 shows a system block diagram of an off-chain interaction authorization system according to some embodiments.

FIG. 2A shows a system block diagram of a hub computer according to some embodiments.

FIG. 2B shows a system block diagram of a processing network computer according to some embodiments.

FIG. 3 shows a system block diagram of a cryptocurrency issuer computer according to some embodiments.

FIG. 4 shows a hybrid system block and flow diagram of an off-chain interaction authorization method according to some embodiments.

FIGS. 5A and 5B show a flowchart of an off-chain interaction authorization method, corresponding to the hybrid diagram of FIG. 4, according to some embodiments.

### DETAILED DESCRIPTION

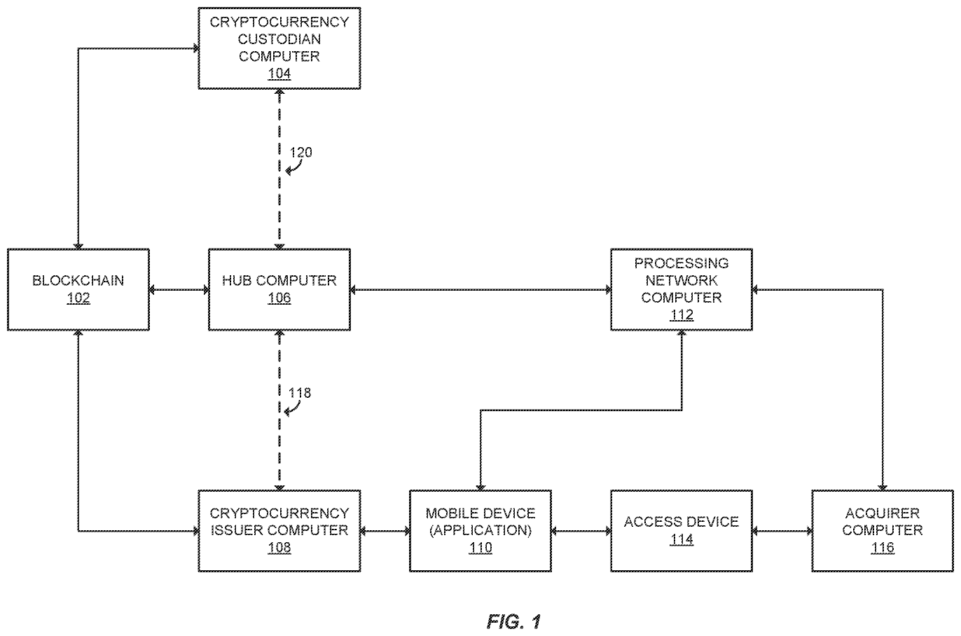

FIG. 1 shows a token-based, off-channel interaction authorization system according to some embodiments. The interaction authorization system comprises a blockchain 102, a cryptocurrency custodian 104, a hub computer 106, a cryptocurrency issuer computer 108, a mobile device (operating a digital wallet application) 110, a processing network computer 112, an access device 114, and an acquirer computer 116. FIG. 1 additionally includes two off-chain channels, a first off-chain channel 118 and a second off-chain channel 120. Although there are two computers 104, 108, one processing network computer 112 and one blockchain 102 in communication with the hub computer 106, it is understood that there can be many cryptocurrency issuer computers, many cryptocurrency custodian computers, many blockchains, and many processing network computers in communication with the hub computer 106.

The components in the system in FIG. 1 can be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); and Secure Hypertext Transfer Protocol (HTTPS).

As stated above, one function of embodiments is to enable a user of a mobile device 110 to perform cryptocurrency interactions (e.g., transactions) with a resource provider (e.g., merchant), operating an access device 114. The mobile device 110 may operate an application, such as a digital wallet application for this purpose among other purposes (including, for example, managing a cryptocurrency portfolio, directly transferring cryptocurrencies between accounts, etc.). The mobile wallet application may be associated with the cryptocurrency issuer computer 108 (e.g., the mobile wallet application may have been provided to the mobile device 110 by the cryptocurrency issuer computer 108). Additionally, the mobile wallet application may be in communication with a cryptocurrency issuer computer 108.

The mobile device 110 may comprise any suitable portable device, such as a smartphone, tablet, or laptop computer. The mobile device 110 may possess a number of communications interfaces, including for example, a cellular communication interface, a Wi-Fi communication interface, Bluetooth communication interface, near-field communication interface, and the like. The mobile device 110 may use any of these communication interfaces to communicate with other devices in the network, including the hub computer 106, the cryptocurrency issuer computer 108, the processing network computer 112, and the access device 114. The mobile device 110 may also comprise an optical interface (such as a camera) that can be used to collect data such as QR codes.

The mobile device 110 may possess an access token (such as a digital wallet token) issued by the processing network computer 112, the hub computer 106, or the cryptocurrency issuer computer 108. This digital wallet token may be used in place of a traditional payment credential (such as a payment account number, PAN) when conducting a transaction with the resource provider operating access device 114. The digital wallet token may indicate to the processing network computer 112 or any other suitable computer in the system that the transaction is to be conducted using cryptocurrency instead of fiat currency.

Additionally, the mobile device 110 may possess a cryptographic key, such as a limited use key (LUK), which may also be issued to mobile device 110 by processing network computer 112, hub computer 106, or cryptocurrency issuer computer 108. The LUK may have a limited lifetime (e.g., for one week or for up to five transactions), such that any data encrypted using the LUK beyond its lifetime may not be validated for a transaction.

During a transaction, the mobile device 110 may receive interaction data from the access device, including an interaction value (e.g., transaction amount, price, etc.), a resource provider identifier, a hash of a secret value (or “secret token”), and any other relevant information (such as a timestamp associated with the transaction, and/or a geographic location, such as a zip code, city name, country name, etc.)

The mobile device 110 may use the LUK to generate a cryptogram. The LUK may be used to encrypt the digital wallet token and any interaction data from the mobile device 110. The mobile device 110 can transmit this cryptogram to the access device 114. The access device can then forward the cryptogram to the processing network computer 112 via the acquirer computer 116. In some embodiments, the cryptogram may be present in an authorization request message (e.g., a standard ISO 8583 formatted message). In addition to the cryptogram, the authorization request message may comprise the interaction amount, the resource provider identifier, an access device identifier, and routing data sufficient to route the authorization request message to the hub computer 106. In some embodiments, the routing data may also include the digital wallet token. In other embodiments, the digital wallet token may only be present in the cryptogram, and the routing data might include a conventional payment token or primary account number. The latter data would be sufficient to route the authorization request message to the processing network computer 112.

In some embodiments, the access device 114 may comprise a device such as a point-of-sale terminal. One function of the access device 114 may be to collect interaction information (e.g., payment information, such as a credit card number, payment token, or digital wallet token) and forward it to processing network computer 112 in order to later receive authorization to complete the interaction. The access device 114 may comprise any number of devices, interfaces, or peripherals in order to perform this function. For example, the access device 114 may comprise a screen that can display interaction information, enabling a user of mobile device 110 to review the interaction information before providing any payment details. Additionally, the access device 114 may use this screen to display QR codes. These QR codes may encode the interaction data described above. The access device 114 may transmit this interaction data by displaying the QR code on the screen, allowing the mobile device 110 to collect the QR code using an optical reader or camera. Additionally, the access device 114 may comprise one or more communication interfaces (e.g., cellular, Bluetooth, Wi-Fi, Ethernet, NFC, Ethernet, etc.) that it may use to communicate with other devices in the network. These communications may include, for example, transmitting interaction data to mobile device 110, receiving a cryptogram from mobile device 110, transmitting the cryptogram to acquirer computer 116, and receiving an authorization response message (indicating whether the interaction was authorized) from acquirer computer 116.

Acquirer computer 116 may comprise a computer system associated with an acquiring entity. In some embodiments, the acquiring entity comprises an acquiring bank that manages an account on behalf of the resource provider (e.g., a merchant). The acquirer computer 116 can receive the cryptogram from access device 114 and forward it to processing network computer 112. Later, the acquirer computer 116 can receive an authorization response message (indicating whether the interaction was authorized) and forward the authorization response message to access device 114. In some embodiments, acquirer computer 116 may be associated with cryptocurrency custodian computer 104. That is, cryptocurrency custodian computer 104 may provide cryptocurrency custodial services (such as storage, for example) for acquirer computer 116, or cryptocurrency custodian computer 104 and acquirer computer 116 may comprise a single computer system.

Processing network computer 112 may comprise a server computer. The processing network computer 112 may route interaction (payment) information between acquirers and issuers (typically issuing banks associated with users), in order to enact payment between the user and the resource provider. The processing network computer 112 may also route authorization request and response messages between these entities, in order to indicate to the resource provider and user whether a transaction has been approved or denied. The processing network computer 112 can perform these functions for both conventional interactions (e.g., those involving payment credentials such as PANs), tokenized interactions, and token based cryptocurrency interactions as disclosed herein. The processing network computer 112 may comprise a “token provider computer” as described in the terms section above, and may have provisioned the digital wallet token to the mobile device 110.

The processing network computer 112 may be in a payment processing network, which may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

Processing network computer 112 may decrypt the cryptogram received from the mobile device 110 in order to determine the digital wallet token, the resource provider identifier, and the interaction value (if these values were not otherwise received in an authorization request message). The processing network computer 112 may decrypt the cryptogram using a cryptographic key corresponding to the LUK issued to the mobile device 110. If the processing network computer 112 is able to decrypt the cryptogram with the LUK and confirms that the LUK that was used to decrypt the cryptogram is valid and has not expired, then the processing network computer 112 may initially determine that the cryptogram is valid.

The processing network computer 112 may determine, based on the digital wallet token (which is an example of an access token), that the interaction taking place between the mobile device 110 and access device 114 (or user and resource provider) is a cryptocurrency-based interaction, rather than a conventional interaction (e.g., a conventional credit or debit card transaction). Using a database or other suitable data structure, the processing network computer 112 may identify another access token such as a “virtual payment account number” or “VPAN” associated with the digital wallet token. The processing network computer 112 can forward at least the VPAN, the interaction value, and the resource provider identifier to hub computer 106.

Hub computer 106 may comprise a server computer that acts as a hub between blockchains, processing network computers, cryptocurrency issuer computers (e.g., cryptocurrency issuer computer 108) and cryptocurrency custodians (e.g., cryptocurrency custodian computer 104). The hub computer 106 maintains off-chain channels between itself, cryptocurrency issuers and cryptocurrency custodians (i.e., off-chain channels 118 and 120). Hub computer 106 may also interface with a blockchain 102. Blockchain 102 can be used to implement the first off-chain channel 118 and the second off-chain channel 120.

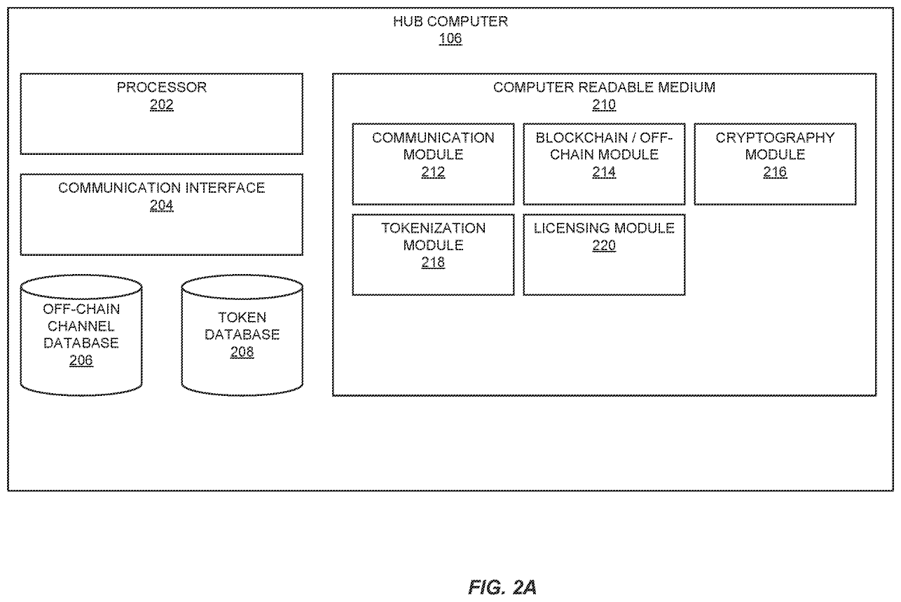

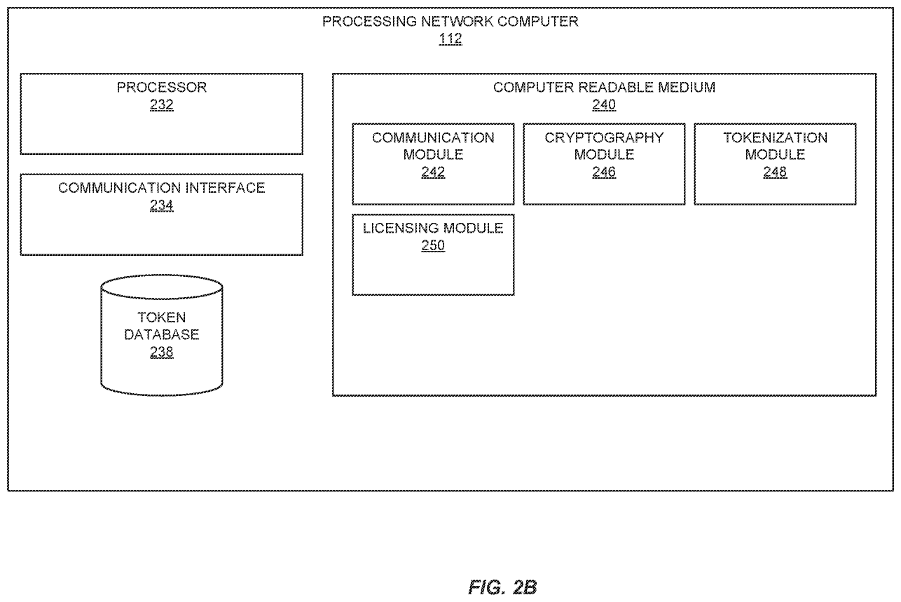

The hub computer 106, its components, and its functions are described in more detail with reference to FIG. 2A below, however, before describing the hub computer 106, it may be helpful to describe off-chain channels in more detail.

Off-chain channels, sometimes referred to as “layer two” channels, are used to perform secure cryptocurrency transactions without broadcasting each transaction to the blockchain. This contrasts with traditional cryptocurrency transactions, where each transaction is broadcast and written to the blockchain. By reducing the number of transactions broadcast to the blockchain, off-chain channels increase the total transaction processing rate of the underlying blockchain.

There are many ways in which off-chain channels can be implemented. In some implementations, off-chain channels are created using a “funding transaction” that is broadcast to the underlying blockchain. In the funding transaction, the two participants in the off-chain channel (such as the hub computer 106 and cryptocurrency issuer computer 108) each contribute some cryptocurrency to the channel. This cryptocurrency cannot be spent or transferred by either participant until the off-chain channel is closed. This closure occurs when a “closing transaction” or “commitment transaction” is written to the blockchain by either one of the participants. This commitment transaction is usually cryptographically signed by both participants, in order to indicate that the participants agree on the channel closure.

The participants are then free to “transact” any number of times by rebalancing the available funds on the channel. For example, the cryptocurrency issuer computer 108 and the hub computer 106 could each contribute 0.5 BTC (Bitcoins) to the first off-chain channel 118 in a funding transaction, for a total of 1 BTC on the off-chain channel. The current balance of the channel would reflect that each participant possesses 0.5 BTC on the channel. The cryptocurrency issuer computer 108 could then pay the hub computer 106 0.1 BTC. After this payment, the channel's state would reflect that the cryptocurrency issuer computer 108 possesses 0.4 BTC and the hub computer 106 possesses 0.6 BTC. If the hub computer 106 and the cryptocurrency issuer computer 108 have completed their transactions, either participant can close the channel by writing a commitment transaction to the blockchain 102. Off-chain channel 120 will then free the cryptocurrency on the channel, allowing the cryptocurrency issuer computer 108 to spend or transfer 0.4 BTC, and the hub computer 106 to spend or transfer 0.6 BTC. Usually, however the participants will rebalance the off-chain channel multiple times before closing out the channel.

In some implementations, participants on the off-chain channel will generate commitment transactions each time the off-chain channel is rebalanced. The participants will each sign their generated commitment transaction, and then transmit it to the other participant. If a participant wants to close the channel, they can sign the received commitment transaction with their own private key. At this point, the commitment transaction has been signed by both participants and can be broadcast to the blockchain to close out the channel. If neither participant is interested in closing the off-chain channel, they can digitally store the commitment transactions until the off-chain channel is rebalanced and new commitment transactions are generated. At this point, the old commitment transactions can be deleted.

Typically, off-chain channels use some form of transaction scripting (such as Bitcoin Transaction Scripting) in order to enforce rules and penalties, rather than relying on participants to behave honestly. An exemplary transaction script is a “time lock” that prevents cryptocurrency from being spent or transferred until a certain amount of time has expired. The table below shows an example of a time lock script in Bitcoin Transaction Scripting:

TABLE 1
Exemplary time-lock script

ScriptPubKey: <expiry time> OP_CHECKLOCKTIMEVERIFY
OP_DROP OP_DUPE OP_HASH160 <pubKeyHash>
OP_EQUALVERIFY OP_CHECKSIG
scriptSIG: <sig> <pubKey>

Alternative time locking scripts can prevent cryptocurrency from being spent until a certain number of additional blocks have been written to the blockchain.

As such, off-chain channels 118 and 120 can be used to implement cryptocurrency payments between the cryptocurrency issuer computer 108 and hub computer 106, and between the hub computer 106 and cryptocurrency custodian computer 104. As such, hub computer 106 can effectively manage cryptocurrency payments between cryptocurrency issuer computer 108 (and by extension, the user of mobile device 110) and cryptocurrency custodian computer 104 (and by extension, the resource provider operating access device 114).

The hub computer 106 may be better understood with reference to FIG. 2A, which shows a hub computer 106 comprising a processor 202, a communications interface 204, an off-chain channel database 206, and a computer readable medium 210, comprising or storing a number of software modules, including a communication module 212, a blockchain/off-chain module 214, and a cryptography module 216.

The hub computer 106 can manage off-chain payment channels between it, cryptocurrency issuer computers, and cryptocurrency custodian computers, in order to enable off-chain cryptocurrency payments between cryptocurrency issuer computers (on behalf of users of mobile devices or customers) and cryptocurrency custodian computers (on behalf of resource providers or merchants). During an interaction, the hub computer 106 can receive an access token and interaction data, including an interaction value (e.g., a transaction amount such as 1 BTC), and a resource provider identifier. Using the access token, the hub computer 106 can identify the cryptocurrency issuer computer and the off-chain channel corresponding to that cryptocurrency issuer computer. Using the resource provider identifier, the hub computer 106 can identify the cryptocurrency custodian computer and the off-chain channel corresponding to that cryptocurrency custodian computer. Via these off-chain channels, the hub computer 106 can request interaction authorization from the cryptocurrency issuer computer, and rebalance the state of the two off-chain channels to enact off-chain payment between the cryptocurrency issuer computer and the cryptocurrency custodian computer. Afterwards, the hub computer 106 can transmit an authorization response message to the access device (e.g., via the processing network computer and the acquirer computer), enabling the resource provider to complete the interaction. In some embodiments, the hub computer 106 and processing network computer 112 may form part of a single computer system. In these embodiments, the computer system may perform functions, including generating digital wallet tokens and provisioning those digital wallet tokens to access devices, as well as decrypting cryptograms received from access devices, and identifying access tokens based on their corresponding digital wallet tokens.

Processor 202 may comprise any suitable data computation device or devices. Processor 202 may be able to interpret code and carry out instructions stored on computer readable medium 210. Processor 202 may comprise a Central Processing Unit (CPU) operating on a reduced instructional set, and may comprise a single or multi-core processor. Processor 202 may also include an Arithmetic Logic Unit (ALU) and a cache memory.

Communication interface 204 may comprise any interface by which hub computer 106 may communicate with other computers or devices. Examples of communication interfaces include: wired interfaces, such as USB, Ethernet, or FireWire, as well as wireless interfaces such as a Bluetooth or Wi-Fi receivers. Hub computer 106 may possess multiple communication interfaces 204. As an example, hub computer 106 may communicate through an Ethernet interface, as well as a USB port.

Hub computer 106 may communicate with other devices or computers using communication interface 204, via one or more secure and authenticated point-to-point channels. These channels may use a standard public key infrastructure. For example, hub computer 106 and a cryptocurrency issuer computer may exchange a symmetric key via their communication interfaces. This key exchange may comprise, for example, a Diffie-Hellman key exchange. After exchanging cryptographic keys, hub computer 106 and the cryptocurrency issuer computer may communicate over a public channel (such as an unsecured network) using a standard authenticated encryption scheme. Messages between hub computer 106 and the cryptocurrency issuer computer can be encrypted with the symmetric cryptographic key. Additional authentication methods, such as digital signatures, can also be used.

The off-chain channel database 206 may comprise a database of information used to identify off-chain channels. This may include, for example, key-value pairs associating access tokens with off-chain channel identifiers or cryptocurrency issuer addresses. It may also include, for example, key-value pairs associating resource provider identifiers with off-chain channel identifiers or cryptocurrency custodian addresses. The hub computer 106 may access this information in order to identify the cryptocurrency issuer associated with an access token received from an access device, in order to subsequently request interaction authorization from the cryptocurrency issuer computer.

Communication module 212 may comprise code, software, or instructions the may be interpreted and executed by processor 202. This software may be used by hub computer 106 in order to communicate with other computers, devices, and entities in the off-chain interaction authorization system, such as the computers, devices, and entities displayed in FIG. 1. This may include code or instructions for: receiving access tokens and interaction values from access devices (or other devices, such as a processing network computer), receiving cryptograms from access devices, transmitting off-chain interaction requests to cryptocurrency issuer computers and cryptocurrency custodian computers, receiving off-chain interaction responses from cryptocurrency issuer computers and cryptocurrency custodian computers, and transmitting authorization response messages to access devices. Communication module 212 may enable hub computer 106 to communicate with other computers and devices according to any appropriate communication protocol, such as the user datagram protocol (UDP), the transmission control protocol (TCP), ISO 8583, etc.

Blockchain/Off-chain module 214 may comprise code or software, executable by processor 202 to enable the hub computer 106 to perform functions associated with managing an off-chain channel or the underlying blockchain corresponding to that channel. For example, the hub computer 106 may use blockchain/off-chain module 214 to open an off-chain channel with a cryptocurrency issuer computer or a cryptocurrency custodian computer by broadcasting an initial recordation (otherwise referred to as an initial transaction or a funding transaction) to the underlying blockchain. Hub computer 106 may also use blockchain/off-chain module 214 to generate commitment transactions that reflect an updated state of the corresponding off-chain channel. Additionally, hub computer 106 may use blockchain/off-chain module 214 to broadcast a closing recordation (otherwise referred to as a closing transaction or commitment transaction) to the underlying blockchain. Further, blockchain/off-chain module 214 may be used by hub computer 106 to access, search, and modify the off-chain channel database 206.

Cryptography module 216 may comprise code or software, executable by processor 202 for performing cryptographic services, including encrypting or decrypting data (such as generating authorization response cryptograms), digitally signing data (such as commitment transactions), performing key exchanges, encrypting messages sent to other systems or devices, and the like.

Returning briefly to FIG. 1, the hub computer 106 may maintain a first off-chain channel 118 with the cryptocurrency issuer computer 108, and a second off-chain channel 120 with cryptocurrency custodian computer 104. The hub computer 106 can use these channels to perform off-chain cryptocurrency transfers between itself, cryptocurrency issuer computer 108 and cryptocurrency custodian computer 104.

Additionally, hub computer 106, cryptocurrency custodian computer 104, and cryptocurrency issuer computer 108 may interface with a blockchain 102, or a network of computers each acting as nodes in blockchain 102. These computer systems may interface (e.g., by broadcasting transactions) with the blockchain in order to open or close off-chain channels and in order to perform off-chain cryptocurrency transactions between each other.

A block diagram of the processing network computer 112 is shown in FIG. 2B, which shows a processing network computer hub computer 112 comprising a processor 232, a communications interface 234, a token database 238, and a non-transitory computer readable medium 240, comprising or storing a number of software modules, including a communication module 242, a cryptography module 246, a tokenization module 248, and a licensing module 250.

The processor 232 and communication interface 234 can be similar to similarly named components in FIG. 2A in hub computer 106, so descriptions therefore need not be repeated here.

The token database 238 may comprise a database of information used to map access tokens to digital wallet tokens. The processing network computer 112 may receive cryptograms encoding digital wallet tokens and other information, and the processing network computer 112 can use token database 208 to identify the corresponding access token (e.g., a virtual PAN). The access token may then be transmitted to the hub computer which identifies the cryptocurrency issuer computer, and the off-chain channel corresponding to the cryptocurrency issuer computer.

Communication module 242 may comprise code, software, or instructions the may be interpreted and executed by processor 202. This software may be used by hub computer 106 in order to communicate with other computers, devices, and entities in the off-chain interaction authorization system, such as the computers, devices, and entities displayed in FIG. 1. Communication module 242 may enable processing network computer 112 to communicate with other computers and devices according to any appropriate communication protocol, such as the user datagram protocol (UDP), the transmission control protocol (TCP), ISO 8583, etc.

Cryptography module 246 may comprise code or software, executable by processor 202 for performing cryptographic services, including encrypting or decrypting data (such as decrypting received cryptograms, or generating authorization response cryptograms), digitally signing data, generating cryptographic keys (such as limited use keys), performing key exchanges, encrypting messages sent to other systems or devices, and the like.

Tokenization module 248 may comprise code or software, executable by processor 232, for implementing tokenization services. These services can include generating and provisioning digital wallet tokens to mobile devices. These services can also include associating digital wallet tokens to access tokens, and “de-tokenizing” digital wallet tokens to identify the corresponding access token. The tokenization module 240 and the processor 232 may also detokenize an access token to obtain a real credential corresponding to that access token. The tokenization module 218 may also be used by the processing network computer 106 to access, search, and modify token database 208.

Licensing module 250 may comprise code or software, executable by processor 232 for generating, distributing, and analyzing digital wallet licenses. A digital wallet license may comprise data used to indicate that a cryptocurrency issuer computer is allowed to request digital wallet tokens for its users and their mobile devices. A digital wallet license may be cryptographically signed by processing network computer 112, in order to indicate that the digital wallet license originated from processing network computer 112. The processing network computer 112 may use the licensing module 250 to generate a digital wallet license and digitally sign it before transmitting it to a cryptocurrency issuer computer. When the cryptocurrency issuer computer requests a digital wallet token for a mobile device, the cryptocurrency issuer computer may transmit the digital wallet license back to processing network computer 112. Processing network computer 112 may use licensing module 250 to determine if the digital wallet license is legitimate (e.g., by verifying the digital signature), before generating a digital wallet token and issuing it to the respective mobile device.

Returning to FIG. 1, cryptocurrency custodian computer 104 may comprise a computer system that performs “custodial” services for other entities. These include storing cryptocurrencies in either “hot” (online connected) storage or “cold” (offline) storage. Cryptocurrency custodian computer 104 may act as a repository for cryptocurrencies. Cryptocurrency custodian computer 104 may maintain an account on behalf of either the acquirer or resource provider, allowing cryptocurrency payments made via the second off-chain channel 120 to eventually reach the resource provider.

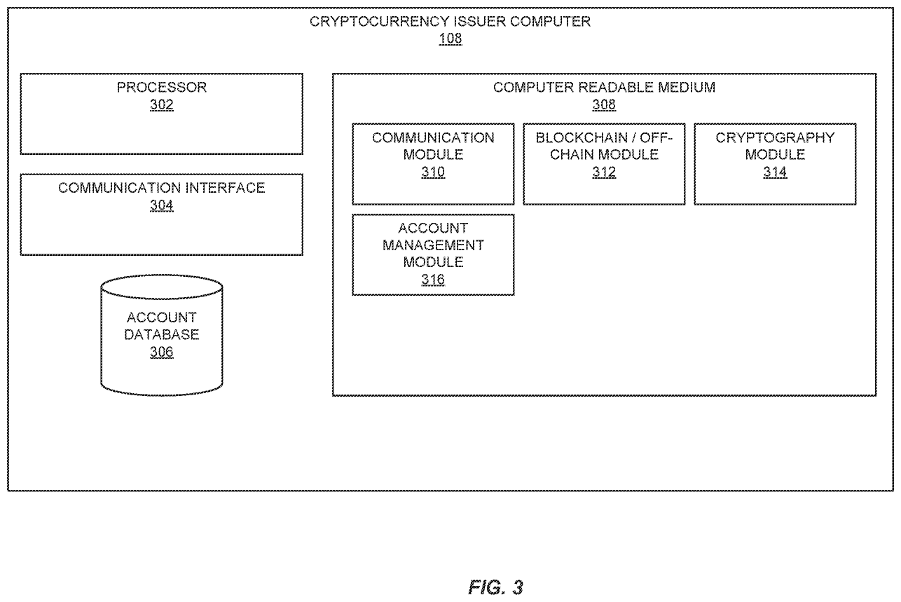

Cryptocurrency issuer computer 108 may comprise a server computer system that maintains cryptocurrency accounts on behalf of clients. The cryptocurrency issuer computer 108 may be part of a cryptocurrency exchange that brokers exchanges of cryptocurrencies between clients, as well as securely storing client cryptocurrencies. The cryptocurrency issuer computer 108 may maintain an account on behalf of the user of mobile device 110. Additionally, the cryptocurrency issuer computer 108 may issue a mobile wallet application to mobile device 110, enabling the user of mobile device 110 to manage their account or their cryptocurrencies. The cryptocurrency issuer computer 108 may communicate with mobile device 110 via this application. Cryptocurrency issuer computer 108 may be better understood with reference to FIG. 3.

FIG. 3 shows a system block diagram of a cryptocurrency issuer computer 108 according to some embodiments. Cryptocurrency issuer computer 108 may comprise a processor 302, a communication interface 304, an account database 306, and a computer readable medium 308. The computer readable medium 308 may comprise or store a number of software modules, including a communication module 310, a blockchain/off-chain module 312, a cryptography module 314, and an account management module 316.

Processor 302 may comprise any suitable data computation device or devices. Processor 302 may be able to interpret code and carry out instructions stored on computer readable medium 308. Processor 302 may comprise a Central Processing Unit (CPU) operating on a reduced instructional set, and may comprise a single or multi-core processor. Processor 302 may also include an Arithmetic Logic Unit (ALU) and a cache memory.

Communication interface 304 may comprise any interface by which cryptocurrency issuer computer 108 may communicate with other computers or devices. Examples of communication interfaces include: wired interfaces, such as USB, Ethernet, or FireWire, as well as wireless interfaces such as a Bluetooth or Wi-Fi receivers. Cryptocurrency issuer computer 108 may possess multiple communication interfaces 304. As an example, cryptocurrency issuer computer 108 may possess and communicate via Ethernet and USB interfaces.

Cryptocurrency issuer computer 108 may communicate with other devices or computers using communication interface 304 via one or more secure and authenticated point-to-point channels. These channels may use a standard public key infrastructure. For example, cryptocurrency issuer computer 108 and a hub computer may exchange a symmetric key via their communication interfaces. This key exchange may comprise, for example, a Diffie-Hellman key exchange. After exchanging cryptographic keys, cryptocurrency issuer computer 108 and the hub computer may communicate over a public channel (such as an unsecured network) using a standard authenticated encryption scheme. Messages between cryptocurrency issuer computer 108 and the hub computer can be encrypted with the symmetric cryptographic key. Additional authentication methods, such as digital signatures, can also be used.

Account database 306 may comprise a database of user accounts and user account information. These may comprise cryptocurrency accounts corresponding to users' cryptocurrency holdings. The database may also store associated “account values” corresponding to the amounts and types of cryptocurrencies held by those users, such as “2 BTC.” Account database 306 may additionally comprise key-value pairs that relate access tokens and mobile devices (or mobile device identifiers) to their corresponding accounts. The cryptocurrency issuer computer 108 may use account database 306 to debit cryptocurrency from user accounts during cryptocurrency based interactions. In some embodiments, in addition to managing a cryptocurrency account for a user, the cryptocurrency issuer computer 108 may also manage a fiat currency account. For example, a bank computer could manage both cryptocurrency and fiat currency accounts for a user.

Communication module 310 may comprise code, software, or instructions the may be interpreted and executed by processor 302. This software may be used by cryptocurrency issuer computer 108 in order to communicate with other computers, devices, and entities in the off-chain interaction authorization system, such as the devices and computers shown in FIG. 1. This may include code or instructions for: receiving off-chain interaction requests from a hub computer, receiving access tokens and interaction values from the hub computer, generating and transmitting off-chain interaction responses to the hub computer, as well as communicating with a mobile device via a mobile wallet application, including transmitting authorization response messages and cryptocurrency account information. Communication module 310 may enable cryptocurrency issuer computer 108 to communicate with other computers and devices according to any appropriate communication protocol, such as the user datagram protocol (UDP), the transmission control protocol (TCP), ISO 8583, etc.

Blockchain/Off-chain module 312 may comprise code, software or instructions that may be interpreted and executed by processor 302 in order to manage off-chain channels and interface with their underlying blockchains. For example, the cryptocurrency issuer computer 108 may use blockchain/off-chain module 312 to open an off-chain channel with a hub computer by broadcasting an initial recordation to the underlying blockchain. Cryptocurrency issuer computer 108 may also use blockchain/off-chain module 312 to generate commitment transactions that reflect an updated state of the corresponding off-chain channel. Additionally, cryptocurrency issuer computer 108 may use blockchain/off-chain module 214 to broadcast a closing recordation to the underlying blockchain. Further, cryptocurrency issuer computer 108 may use blockchain/off-chain module 312 to interpret off-chain interaction request messages and generate off-chain interaction response messages, in order to update the state of the off-chain channel.

Cryptography module 314 may comprise code or software, executable by processor 302 for performing cryptographic services, including encrypting or decrypting data, and signing data, including signing commitment transactions, signing interaction data to generate off-chain interaction responses, etc. Cryptography module 314 may also be used by cryptocurrency issuer computer 108 to perform key exchanges.

Account management module 316 may comprise code or software, executable by processor 302 for managing user accounts and interfacing with account database 306. The cryptocurrency issuer computer 108 may use account management module 316 to debit a user's account based on an interaction value received in an off-chain interaction request, e.g., by subtracting the interaction value from a corresponding account value.

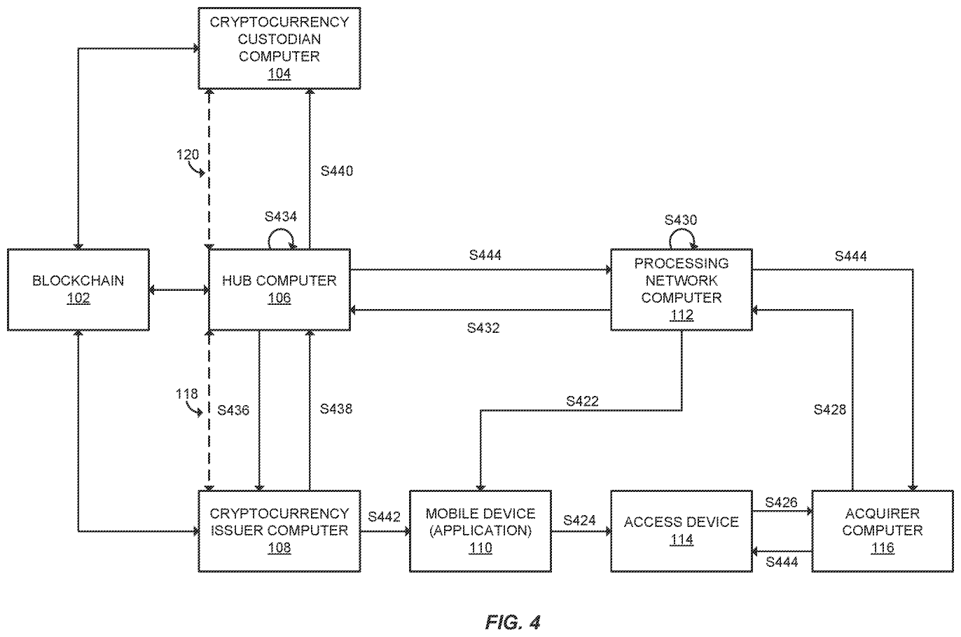

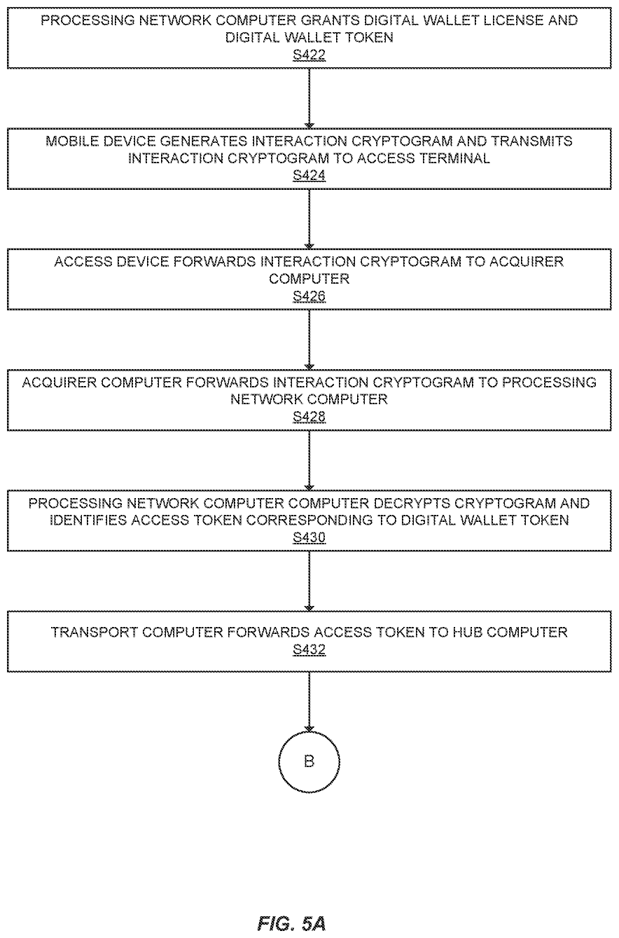

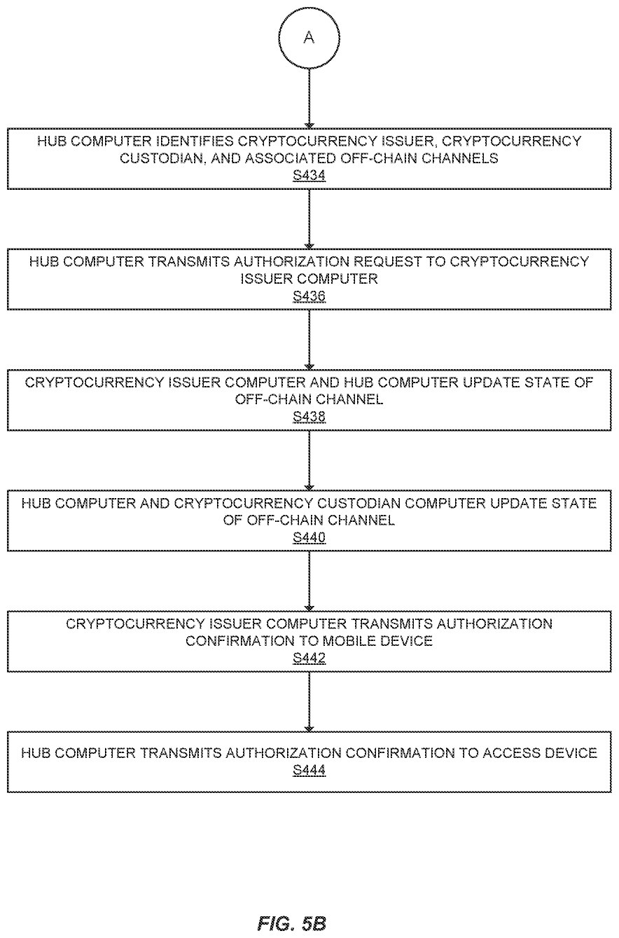

Having described systems and computers according to some embodiments with reference to FIGS. 1-3, it may be helpful to describe methods according to embodiments of the present disclosure. FIG. 4 shows a hybrid system and flow diagram, corresponding to the system of FIG. 1. Also shown on FIG. 4 are steps S422-S444, corresponding to some methods according to some embodiments, these steps are also shown in FIGS. 5A and 5B.

At step S422, the processing network computer 112 can grant a digital wallet license to the cryptocurrency issuer computer 108 and transmit a digital wallet token to the mobile device 110.

In some embodiments, the cryptocurrency issuer computer 108 can transmit a request for a digital wallet license to the processing network computer 112. The request can comprise information used to identify the cryptocurrency issuer computer 108 (e.g., a public key associated with the cryptocurrency issuer computer 108), such as a cryptocurrency issuer address (e.g., an IP address for the cryptocurrency issuer computer 108). The processing network computer 112 can analyze the request, generate a digital wallet license (using, for example, licensing module 220 from FIG. 2B), then transmit the digital wallet license to the cryptocurrency issuer computer 108.

Later, when the cryptocurrency issuer computer 108 is enrolling a user in the off-chain interaction authorization service, the cryptocurrency issuer computer 108 can generate an access token associated with a user account of the user operating a mobile device (e.g., the user's smartphone). The cryptocurrency issuer computer 108 can transmit a request to issue a digital wallet token to the processing network computer 112. The request for the digital wallet token can include the previously generated access token generated. The processing network computer 112 can subsequently generate a digital wallet token, associate the digital wallet token with the access token (e.g., by storing the tokens in conjunction with one another in a database), and transmit the digital wallet token to the mobile device 110. Further, in some embodiments, the processing network computer 112 can transmit a limited use key to the mobile device 110. The mobile device 110 can then use the digital wallet token and limited use key during a later interaction (e.g., a transaction).

At step S424, during an interaction between a user of mobile device 110 and a resource provider operating access device 114, mobile device 110 can generate an interaction cryptogram and transmit the interaction cryptogram to access device 114. The interaction cryptogram can comprise one or more of interaction data, digital representations of data corresponding to the interaction, as well as the digital wallet token, encrypted using a limited use key. The interaction data can comprise, for example, an interaction value (such as the price or cost of the good or service, represented in cryptocurrency), as well as a resource provider identifier (used to identify the resource provider operating the access device). The interaction data can additionally comprise other relevant interaction information, such as a timestamp corresponding to the interaction, a merchant category code, etc. Access device 114 may transmit the interaction data to the mobile device 110 prior to step S424, enabling mobile device 110 to generate the interaction cryptogram. In some embodiments, the digital wallet application operating on mobile device 110 can request the interaction data in the processing data object list (PDOL) of the file control information (FCI) sent to the mobile device 110 during the interaction. Alternatively, access device 114 may generate and display a QR code that the mobile device 110 can scan in order to gain access to the interaction data. In some cases, the mobile device 110 and/or the access device may include information (e.g., network addresses, pseudo account numbers, etc.) in any message that is eventually transmitted to the acquirer computer 116 and/or the processing network 112 that would be sufficient to route the message.

Optionally at step S424, mobile device 110 can transmit an initial value to cryptocurrency issuer computer 108. This initial value can correspond to or equal the interaction value. The initial value can indicate to the cryptocurrency issuer computer 108 that the user of the mobile device intends to use or spend that amount of cryptocurrency, and thus the cryptocurrency issuer computer 108 should expect an authorization request for that amount. The cryptocurrency issuer computer 108 can optionally “lock” that amount from the user's cryptocurrency account.

At step S426, the access device 114 can forward the interaction cryptogram to the acquirer computer 116. Subsequently at step S428, the acquirer computer 116 can forward the interaction cryptogram to the processing network computer 112.

At step S430, the processing network computer 112 can decrypt the interaction cryptogram and identifies an access token corresponding to the digital wallet token. The processing network computer 112 can use a cryptographic key corresponding to the limited use key to decrypt the cryptogram to retrieve the access token and the interaction value (along with any other interaction data, such as a resource provider identifier). In other embodiments, the digital wallet token, interaction amount, and the resource provider identifier are in the authorization request message, along with the cryptogram. In such embodiments, the decryption of the cryptogram by the processing network computer 112 using a valid limited use key, and the comparison of the decrypted data to the data in the authorization request message may serve to validate the authorization request message.

Further, the processing network computer 112 can use a token database (such as token database 238 from FIG. 2B) to determine an access token corresponding to the digital wallet token. Optionally at step S430, prior to determining a cryptocurrency issuer address (i.e., in step S434), the processing network computer 112 can determine based on the access token or the digital wallet token that the interaction comprises a cryptocurrency-based interaction. This may be helpful if the processing network computer typically processes non-cryptocurrency based interactions, such as credit card or debit card interactions. If the transaction is not a cryptocurrency transaction, then the processing network computer 112 may transmit the authorization request message to an issuer computer for authorization as is done conventionally.

At step S432, the processing network computer 112 can transmit the access token, interaction value, and any other interaction data, such as the resource provider identifier to the hub computer 106.

Referring now to FIG. 5B, at step S434, the hub computer 106 can identify the cryptocurrency issuer computer 108, the cryptocurrency custodian computer 104, and their associated off-chain channels, e.g., the first off-chain channel 118 and the second off-chain channel 120. The hub computer 106 can use the access token, the resource provider identifier, and an off-chain channel database (such as off-chain channel database 206 from FIG. 2A), to identify these entities and channels. In some embodiments, the hub computer 106 can determine a cryptocurrency issuer computer address using the access token, the cryptocurrency issuer address associated with the cryptocurrency issuer computer 108, and determine a cryptocurrency custodian computer based on the resource provider identifier.

The first off-chain interaction channel 118 may have been previously opened by the hub computer 106 and cryptocurrency issuer computer 108. The first off-chain interaction channel 118 may have been formed by at least a first initial recordation between the hub computer 106 and cryptocurrency issuer computer 108 on blockchain 102 (e.g., a funding transaction). Further, the first off-chain interaction channel 118 may later be closed by a first closing recordation between the hub computer 106 and the cryptocurrency issuer computer 108 on the blockchain 102 (e.g., a commitment transaction).

Likewise, the second off-chain interaction channel 120 may have been previously opened by the hub computer 106 and the cryptocurrency custodian computer 104. The second off-chain interaction channel 120 may have been formed at least by a second initial recordation between the hub computer 106 and cryptocurrency custodian computer 104 on blockchain 102 (e.g., a funding transaction). Further, the second off-chain interaction channel 120 may later be closed by a second closing recordation between the hub computer 106 and the cryptocurrency custodian computer 104 on the blockchain 102 (e.g., a commitment transaction).

The terms “first” and “second,” are intended only to distinguish the off-chain interaction channels, their corresponding initial recordations and corresponding closing recordations, not to indicate, for example, the order in which the channels were opened or closed.

At step S436, having identified the cryptocurrency issuer computer 108 based on the access token, the hub computer 106 can transmit a first off-chain interaction request comprising the interaction value to the cryptocurrency issuer computer 108. In some embodiments, the first off-chain interaction request additionally comprises the access token and any associated interaction data.

The cryptocurrency issuer computer 108 can use the access token, interaction value, and other interaction data in order to determine whether to approve or deny the interaction. The cryptocurrency issuer computer 108 can, for example, check a user account associated with the access token to determine if the user possesses enough cryptocurrency to complete the interaction. Additionally, the cryptocurrency issuer computer 108 can perform fraud detection using the interaction information in order to determine if the interaction is legitimate. For example, the cryptocurrency issuer computer 108 can analyze a time stamp, or a geographic location associated with the interaction to determine if it is an unusual place or time for the user to attempt to perform an interaction. Additionally, the cryptocurrency issuer computer 108 can update the user's account balance, by identifying a user account corresponding to the access token and the mobile device and subtracting the interaction value from an account value associated with the user account.

At step S438, provided the cryptocurrency issuer computer 108 approves the interaction, the cryptocurrency issuer computer 108 and hub computer 106 can update the state of the first off-chain channel 118 in order to enact payment from the user's cryptocurrency account. Updating the state of the channel depends on the particular off-chain channel implementation. In some embodiments, the cryptocurrency issuer computer 108 can sign interaction data including the interaction value to form a cryptocurrency issuer computer cryptographic signature. This cryptocurrency issuer computer cryptographic signature can be used to create a first off-chain interaction response and sent to the hub computer 106. In some embodiments, the first off-chain interaction response may comprise a commitment transaction. If the hub computer 106 later wishes to close the channel, it can sign the first off-chain interaction response with its own private key and broadcast it to blockchain 102. In other embodiments, the first off-chain interaction response may comprise a signed cryptographic promise to deliver cryptocurrency in the amount of the interaction value. The hub computer 106 may later deliver this signed cryptographic promise to cryptocurrency custodian computer 104 via the second off-chain channel 120 in order to enact payment between the cryptocurrency issuer computer 108 and cryptocurrency custodian computer 104.

At step S440, after receiving the first off-chain interaction response message from the cryptocurrency issuer computer 108, and updating the first off-chain interaction channel 118, the hub computer 106 and cryptocurrency custodian computer 104 can update the state of the second off-chain interaction channel 120. How the hub computer 106 and cryptocurrency custodian computer 108 update the second off-chain interaction channel 120 depends on the particular implementation of the second off-chain interaction channel. In some embodiments, the hub computer can transmit a second off-chain interaction request comprising the interaction value, the resource provider identifier, and optionally a second hub computer cryptographic signature to the cryptocurrency custodian computer 104. The second off-chain interaction request may essentially amount to a signed cryptographic promise, indicating that the hub computer 106 will transfer an amount of cryptocurrency equal to the interaction value to the cryptocurrency custodian computer 104. The second off-chain interaction request may also comprise a commitment transaction, signed by the hub computer 106. If the cryptocurrency custodian computer 104 wants to close the channel and collect the cryptocurrency, it can sign the second off-chain interaction request and broadcast it to blockchain 102.

After receiving the second off-chain interaction request, the cryptocurrency custodian computer 104 may generate and sign a second off-chain interaction response, comprising a cryptocurrency custodian computer cryptographic signature, and transmit it to the hub computer 106. The second off-chain interaction response may indicate that the cryptocurrency custodian computer accepts the off-chain cryptocurrency transfer. The second off-chain interaction response may comprise a commitment transaction, signed by the cryptocurrency custodian computer.

At step S442, the cryptocurrency issuer computer 108 can transmit a confirmation message to the application on the mobile device 110 for the interaction. This confirmation message can comprise authorization confirmation, indicating to the user of the mobile device 110 that the interaction between the user and the resource provider has been approved, and that the user's account has been debited in the amount of the interaction value.

At step S444, the hub computer 106 can transmit an authorization response message for the interaction to the access device 114, via (optionally) the processing network computer 112, and the acquirer computer 116. In some embodiments, the hub computer 106 instead transmits the authorization response message to the processing network computer 112, which thereafter generates an authorization cryptogram comprising the authorization response message and transmits the authorization cryptogram to the access device 114.

After step S444, the hub computer 106 (or the cryptocurrency issuer computer 108) can optionally close the first off-chain channel 118 by broadcasting the closing recordation to a computer network (i.e., a blockchain network) corresponding to blockchain 102. The hub computer 106 can do this if the interactions between itself and the cryptocurrency issuer computer 108 are complete, or if the channel funds have become totally deplete, or for other reasons (e.g., suspected fraud, renegotiating relationship between the two entities, etc.).

Once a participant (e.g., the hub computer 106) broadcasts the closing recordation (e.g., a commitment transaction signed by both the hub computer 106 and the other party on the off-chain channel), the closing recordation can be included in a block appended to the blockchain (e.g., a “mined” block). In order to include the closing recordation, a “miner” needs to first confirm the closing recordation, then generate a proof-of-work. Confirming the closing recordation typically involves verifying that the cryptocurrency corresponding to the closing recordation has not been double spent. In some embodiments, the closing recordation may include a mining fee to incentivize miners to include the closing recordation in the next block they mine. Once a miner has confirmed the closing recordation and agreed to include the closing recordation in the next block, the miner can begin the time-consuming process of generating the proof-of-work.

In some blockchains, the proof-of-work function involves determining a hash value that is lower than a target hash value. Because hash values are often unpredictable and appear random, generating the proof-of-work is typically a time-consuming, trial-and-error based process, which can involve guessing a nonce that will produce the desired hash value, when included with the data (e.g., transactions) to be written to that block. Blockchains such as the Bitcoin blockchain have a “difficultly” value that relates to the probability that a correct proof-of-work is generated. This difficulty value is often high in order to reduce the rate at which blocks are added to the blockchain (for Bitcoin, roughly once every 10 minutes). Once a miner has discovered the proof-of-work, the block including the closing recordation can be broadcast through the blockchain network and added to the blockchain. Subsequently, the participants on the off-chain channel can spend the cryptocurrency previously on the channel (subject to the terms of any smart-contracts or other limitations, as described above).

In some embodiments, if the resource provider operating the access device 114 wishes to be paid in fiat currency rather than cryptocurrency, then a clearing and settlement process can be performed. In a periodic settlement process, the acquirer computer 116 may be owed an aggregate amount of fiat currency for the accounts of the resource providers that it services. In some embodiments, the cryptocurrency custodian computer 104 can sell or otherwise convert any aggregate amount of cryptocurrency owed to the acquirer operating the acquirer computer 116 to fiat currency. The acquirer computer 116 may receive that aggregate amount of fiat currency from the cryptocurrency custodian computer 104 directly or via the processing network computer 112. In other embodiments, after the off-chain channels are closed, then the hub computer 106 could provide the fiat currency in the amount of the cryptocurrency that each of the cryptocurrency custodian computer 104 and the cryptocurrency issuer computer 108 are owed, and the blockchain 102 could be updated with this settlement transaction. Note that these recordation steps on the blockchain 102 can also be performed with an initial transaction opening a channel.

Embodiments of the invention have a number of advantages. In embodiments of the invention, an interaction such as a payment transaction can be conducted using cryptocurrency. Further, because off-chain channels are used to record and conduct transfers between issuer computers, custodian computers, etc., each transaction need not be recorded to a blockchain. This saves a significant amount of processing speed and processing work by computers in a blockchain network, which would otherwise require data and energy intensive mining for every transaction.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

What is claimed is:

1. A method comprising:
receiving, by a hub computer, an access token and an interaction value in an interaction;
determining, by the hub computer, a cryptocurrency issuer address using the access token, the cryptocurrency issuer address associated with a cryptocurrency issuer computer;
transmitting, by the hub computer, to the cryptocurrency issuer computer, a first off-chain interaction request comprising the interaction value;
receiving, by the hub computer, from the cryptocurrency issuer computer, a first off-chain interaction response comprising a cryptocurrency issuer computer cryptographic signature, wherein the first off-chain interaction request occurs in a first off-chain interaction channel between the hub computer and the cryptocurrency issuer computer, the first off-chain interaction channel formed by at least a first initial recordation between the hub computer and the cryptocurrency issuer computer on a blockchain; and
transmitting, by the hub computer, an authorization response message for the interaction.

2. The method of claim 1, wherein the first off-chain interaction request comprises a request to authorize the interaction.

3. The method of claim 1, wherein the first off-chain interaction response comprises interaction data including at least the interaction value, and wherein the cryptocurrency issuer computer cryptographic signature corresponds to the interaction data.

4. The method of claim 1, wherein the first off-chain interaction request additionally comprises the access token.

5. The method of claim 1, wherein the first off-chain interaction request additionally comprises a first hub computer cryptographic signature.

6. The method of claim 1, further comprising:
receiving, by the hub computer, a resource provider identifier;
determining, by the hub computer, a cryptocurrency custodian computer based on the resource provider identifier;
transmitting, by the hub computer, to the cryptocurrency custodian computer, a second off-chain interaction request comprising the interaction value, the resource provider identifier, and a second hub computer cryptographic signature; and
receiving, by the hub computer, from the cryptocurrency custodian computer, a second off-chain interaction response comprising a cryptocurrency custodian computer cryptographic signature, wherein the second off-chain interaction request occurs in a second off-chain interaction channel between the hub computer and the cryptocurrency custodian computer, the second off-chain interaction channel formed at least by a second initial recordation between the hub computer and the cryptocurrency custodian computer on the blockchain.

7. The method of claim 1, further comprising:
receiving, by the hub computer, a resource provider identifier;
determining, by the hub computer, a cryptocurrency custodian computer based on the resource provider identifier; and
transmitting, by the hub computer, to the cryptocurrency custodian computer, the first off-chain interaction response comprising the cryptocurrency issuer computer cryptographic signature.

8. The method of claim 7, wherein the cryptocurrency custodian computer is associated with an acquirer computer, which holds an account of a resource provider corresponding to the resource provider identifier, and wherein the access token is received from a processing network computer via the acquirer computer, which converted a digital wallet token from an access device of the resource provider to the access token.

9. A hub computer comprising:
a processor; and
a non-transitory computer readable medium coupled to the processor, the non-transitory computer readable medium comprising code, executable by the processor, for performing steps comprising:
receiving an access token and an interaction value for an interaction;
determining a cryptocurrency issuer address using the access token, the cryptocurrency issuer address associated with a cryptocurrency issuer computer;
transmitting, to the cryptocurrency issuer computer, a first off-chain interaction request comprising the interaction value;
receiving, from the cryptocurrency issuer computer, a first off-chain interaction response comprising a cryptocurrency issuer computer cryptographic signature, wherein the first off-chain interaction request occurs in a first off-chain interaction channel between the hub computer and the cryptocurrency issuer computer, the first off-chain interaction channel formed at least by a first initial recordation between the hub computer and the cryptocurrency issuer computer on a blockchain; and
transmitting, by the hub computer, an authorization response message for the interaction.

10. The hub computer of claim 9, wherein the access token and the interaction value are received from a processing network computer in communication with an access device.

11. The hub computer of claim 9, wherein the steps further comprises:
prior to determining the cryptocurrency issuer address, determining, by a processing network computer, based on the access token that the interaction comprises a cryptocurrency-based interaction.

12. The hub computer of claim 9, wherein the steps further comprise closing the first off-chain interaction channel by broadcasting a closing recordation to the blockchain.

13. The hub computer of claim 9, wherein the access token is mapped to a digital wallet token stored in a processing network computer, and a mobile device operated by a user that conducts an interaction with a resource provider.

14. The hub computer of claim 13, wherein the steps further comprise:
transmitting, to a cryptocurrency custodian computer, a second off-chain interaction request comprising a resource provider identifier and the interaction value; and
receiving, from the cryptocurrency custodian computer, a second off-chain interaction response comprising a cryptocurrency custodian computer cryptographic signature, wherein the second off-chain interaction request occurs in a second off-chain interaction channel between the hub computer and the cryptocurrency custodian computer, the second off-chain interaction channel formed by at least a second initial recordation between the hub computer and the cryptocurrency issuer computer on the blockchain.

15. The hub computer of claim 13, wherein the non-transitory computer readable medium further comprises a blockchain/off-chain module.

16. The hub computer of claim 13, wherein the access token and the interaction value are received from the processing network computer in communication with an access device, and wherein the hub computer transmits the authorization response message to the access device via the processing network computer.

17. A method comprising:
receiving, by a cryptocurrency issuer computer, an off-chain interaction request comprising an interaction value from a hub computer in communication with an access device, the interaction value received by the hub computer from an access device interacting with a mobile device, wherein the off-chain interaction request occurs in an off-chain interaction channel between the hub computer and the cryptocurrency issuer computer, the off-chain interaction channel formed by at least an initial recordation between the hub computer and the cryptocurrency issuer computer on a blockchain;
signing, by the cryptocurrency issuer computer, interaction data including the interaction value to form a cryptocurrency issuer computer cryptographic signature;
transmitting, by the cryptocurrency issuer computer, to the hub computer, an off-chain interaction response comprising the cryptocurrency issuer computer cryptographic signature; and
transmitting, by the cryptocurrency issuer computer, a confirmation message to an application on the mobile device for an interaction between the mobile device and the access device.

18. The method of claim 17, wherein the method further comprises:
receiving, by the cryptocurrency issuer computer, a communication comprising an initial value from an application on a mobile device of a user for an interaction, the application associated with the cryptocurrency issuer computer, wherein the initial value is equal to the interaction value.

19. The method of claim 17, further comprising:
transmitting, by the cryptocurrency issuer computer, a request for a digital wallet license to a processing network computer;
receiving, by the cryptocurrency issuer computer, from the processing network computer, a digital wallet license;
obtaining, by the cryptocurrency issuer computer, an access token associated with a user account of a user operating a mobile device; and
transmitting, by the cryptocurrency issuer computer, to the processing network computer, a request to issue a digital wallet token, wherein the processing network computer subsequently generates a digital wallet token and associates the digital wallet token with the access token, then transmits the digital wallet token to the mobile device.

20. The method of claim 17, wherein the off-chain interaction request additionally comprises an access token, and wherein the method further comprises:
identifying, by the cryptocurrency issuer computer, a user account corresponding to the access token and the mobile device; and
subtracting, by the cryptocurrency issuer computer, the interaction value from an account value associated with the user account.
